(19) United States
(12) Patent Application Publication
(10) Pub. No.: US 2014/0027333 A1
(43) Pub. Date: Jan. 30, 2014

(54) HOLDING STRUCTURE FOR SIMULTANEOUSLY HOLDING A PLURALITY OF CONTAINERS FOR MEDICAL, PHARMACEUTICAL OR COSMETIC APPLICATIONS AND TRANSPORT OR PACKAGING CONTAINER COMPRISING SUCH A HOLDING STRUCTURE

(71) Applicant: Schott AG, (US)

(72) Inventors: Edgar PAWLOWSKI, Stadecken-Elsheim (DE); Kai WISSNER, Mainz (DE); Joel COULON, St. Gallen (CH); Ralph LOVIS, Winterthur Schweiz (DE); Claudia DIETRICH, Staad (CH)

(21) Appl. No.: 13/886,722

(22) Filed: May 3, 2013

Related U.S. Application Data
(60) Provisional application No. 61/642,142, filed on May 3, 2012.

(30) Foreign Application Priority Data
May 3, 2012 (DE) 10 2012 103 896.1

(51) Int. Cl. A61J 1/18; A61J 1/14

(52) U.S. Cl. CPC A61J 1/18; A61J 1/14
USPC 206/438; 248/346.03; 248/346.04

(57) ABSTRACT

A supporting structure for concurrently holding a plurality of cylindrical containers for substances for medical, pharmaceutical or cosmetic applications is provided. The supporting structure includes a supporting base having a plurality of receptacles, which are configured such that the containers can be inserted into the associated receptacles, wherein the receptacles extend in the longitudinal direction of the containers and are configured to hold side wall portions of the containers at least partially clamped. The receptacles are continuous side walls, wherein the opening widths of the receptacles can be adjusted by a coordinated adjustment of the side walls of the receptacles between a first position, in which the containers can be inserted into the receptacles, and a second position in which the containers are clamped. The bottoms or upper ends of the containers are exactly fixed at a given height despite tolerances.

### FIELD OF THE INVENTION

The present invention relates generally to the concurrent supporting of a plurality of containers for the storage of substances for medical, pharmaceutical or cosmetic applications, in particular of flasks (vials), and more particularly to the concurrent supporting of a plurality of containers in a supporting structure in such a manner that these, while they are held in a supporting structure provided for this purpose, may be further processed in filling or processing units, in particular in a sterile tunnel, in a filling unit for liquid medical or pharmaceutical applications or in a freeze-dryer therefor. The present invention further relates to a transport and/or packaging container with at least one such supporting structure and optionally with an integrated sensor and/or a protection against plagiarism.

### BACKGROUND OF THE INVENTION

Medication containers, for example vials, ampoules or carpoules, are widely used as containers for preservation and storage of medical, pharmaceutical or cosmetic preparations to be administered in a liquid form, in particular in pre-dosed amounts. These generally have a cylindrical shape, can be made of plastic or glass and are available in large quantities at low costs. In order to fill the containers under sterile conditions as efficiently as possible concepts are increasingly used according to which the containers are already packaged in a transport or packaging container at the manufacturer of the containers under sterile conditions, which are then unpacked and further processed at a pharmaceutical company under sterile conditions, in particular in a so-called sterile tunnel.

For this purpose, various transport and packaging container are known from the prior art, in which a plurality of medication containers are concurrently arranged in a regular arrangement, for example in a matrix arrangement along rows and columns extending perpendicular thereto. This has advantages in the automated further processing of the containers since the containers can be passed to processing stations, for example to processing machines, robots or the like, at controlled positions and in a predetermined arrangement. For this purpose, supporting structures are used, in which a plurality of containers can be supported concurrently in a predetermined regular arrangement. For the transfer to a processing station it is just required to properly position and open the transport and packaging container. The downstream processing station will then know at what position and in what arrangement the containers to be processed further are arranged.

Such a transport and packaging container and a corresponding packaging concept are disclosed for example in U.S. Pat. No. 8,118,167 B2. The further processing of the containers is, however, always performed such that the supporting structure will be removed from the transport and packaging container, that the containers will be removed from the supporting structure and isolated and then individually placed on a conveyor, in particular a conveyor belt, and passed to the processing stations for further processing. This limits the speed of processing that can be achieved. Particularly in the isolation of the containers by means of cell wheels or the like, it always occurs that individual containers abut uncontrolled, which results in an undesired abrasion and subsequently in a contamination of the interior volume of the containers or of the processing station and in an impairment of the outer appearance of the containers which is undesirable.

U.S. Pat. No. 8,100,263 B2 discloses a portable transport and packaging container that can be packed in a sterile manner, in which a plate-shaped supporting structure can be inserted in which a plurality of medication containers are held in a regular arrangement. Firstly, the individual medication containers are placed loosely in receptacles, which are formed in the supporting structure. Then, the supporting structure is placed in the transport and packaging container and this is surrounded by a gas-impermeable plastic tube. Upon subsequent evacuation of the packaging unit thus formed, the plastic tube is pressed into the spaces between the medication containers due to the negative pressure prevailing in the tube, which, on the one hand, results in a stabilization of the position of the medication containers in the supporting structure and, on the other hand, in a prevention of further uncontrolled collisions of adjacent medication containers. During the evacuation and the subsequent opening of the plastic tube, however, the medication containers may slip sideways, increasing the efforts required for automation for processing further the medication containers. In addition, the medication containers may still collide uncontrollably after opening of the plastic tube, resulting in the aforementioned disadvantages. The medication containers cannot be processed further while being in the transport or packaging container or in the supporting structure, but must be isolated first in the conventional manner and handed over to downstream processing stations.

Other comparable transport and packaging containers and supporting structures are disclosed in WO 2011/135085 A1, US 2011/0277419 A1, WO 2012/025549 A1, WO 2011/015896 A1, WO 2012/007056 A1 and WO 2009/015862 A1. However, for the further processing the medication containers must always be separated or isolated. A batch-wise further processing of the medication containers while being accommodated in a plate-shaped supporting structure, as mentioned above, is not possible.

DE 100 12 575 A1 of the applicant discloses the clamping of syringe bodies in a supporting plate made of plastic. Circumferential projections are formed around the openings of the supporting plate that act as holding means and provide a further clamping. A coordinated adjustment of the opening width of these openings is not possible, since the supporting plate is rigid.

U.S. Pat. No. 5,950,832 discloses a supporting structure for microcentrifuge tubes, which are tapered at their lower ends. The supporting structure comprises an elastic member and a rigid member. The diameter of bores of the elastic member is smaller than the outer diameter of the microcentrifuge tubes, thereby enabling the clamping. A coordinated adjustment of the opening width of the bores is not disclosed.

WO 2009/015862 A1 discloses a clamping in the region of the side walls of containers or at their neck portions by means of holding means. A coordinated adjustment of the opening width of these holding means is not disclosed.

GB 2478703 A discloses a supporting structure that consists of two parts that can be folded to each other. The receptacles of the two parts are offset from each other so that the containers are arranged in an interleaved manner to thereby double the packaging density, but a good access to the containers is accomplished in the unfolded position.

In any case, a direct contact of the bottoms of the medication containers, in particular of the bottoms of vials, with a supporting plane is not possible in conventional supporting structures. This, however, makes a further process of the medication containers difficult, in particular, when their content shall be subjected to a freeze-drying process (also known as lyophilization or sublimation drying). Furthermore, further processing of the medication containers directly in the supporting structures is not possible, because they are either held rigidly or sufficient access is not granted for further processing, so that the medication containers conventionally always had to be removed from the supporting structures for the further processing

### SUMMARY OF INVENTION

It is an object of the present invention to further enhance a supporting structure for concurrently holding a plurality of containers for substances for medical, pharmaceutical or cosmetic applications, in particular of vials made of glass, such that a sterile packaging, de-packaging and further processing of the containers is possible in an easy and cost-efficient manner. According to a preferred further aspect of the present invention such a supporting structure shall be configured particularly for a further processing of the containers while these are supported in the supporting structure. According to a further aspect of the present invention, a corresponding transport and packaging container is to be provided having at least one such supporting structure.

In a supporting structure according to the invention the containers are supported in the supporting structure by friction or clamped. For frictional supporting or clamping the cylindrical containers receptacles are provided which are preferably formed such that they are circumferential and extend in the longitudinal direction of the containers. As is well-known, a frictional coupling only require a sufficient normal force onto the surfaces to be coupled together. The mutual displacement between the container and supporting structure is thus prevented as long as the counteracting force caused by the static friction between the supporting structure and the container is not exceeded. The frictional holding effect stops and the surfaces slide on each other, if the tangential load force is greater than the static friction. However, the latter is unlikely for the relatively low weights of the containers to be accommodated in the supporting structure, but may be utilized in order to displace the containers while being supported in the supporting structure from a first position axially in a second position, in which these can be processed further, e.g. in which their openings are closed with a stopper or in which an outer cap (for example a beaded cap or crimp) often made from aluminum sheet is placed on the stopper.

Suitably the frictional coupling is accomplished either below the expanded upper rim of the containers, i.e. at its constricted neck or neck portion below the upper rim, or in the region of the cylindrical side wall. According to the present invention a support of the bottoms of the containers is in general not necessary, so that an access to the bottom sides (bottoms) of the containers held accommodated in the supporting structure is in general possible. According to the present invention this enables that the containers can be further processed while being accommodated in the supporting structure. In other words, the containers can be processed further batch-wise in the supporting structures, but remain reliably and free of collisions held in the supporting structures during the further processing, resulting in significant advantages with regard to processing speed and in benefits for the automation of processing units and thus overall results in even more economical and more cost-efficient processes. The containers can be raised, in particular axially, or rotated in the supporting structure. According to further embodiments the containers can be lyophilized also in the supporting structure, because a direct contact of the bottoms to a cooling finger of a freeze-dryer is possible. Bottoms or upper ends of the containers can be fixed in a simple manner at a height level, so that all bottoms can be arranged in a common plane, which allows a direct contact to planar processing stations, particularly to a cooling finger or a cooling tray of a freeze-dryer. Furthermore, a direct glass-glass contact of adjacent containers is reliably prevented, effectively preventing abrasion and contaminants within the further processing plant and thus enabling significantly longer operation periods and maintenance intervals of the stations. Furthermore, scratches or the generation of particles can be effectively prevented on or in the containers.

The supporting structure according to the invention thereby suitably permits removing the containers towards the upper side or lower side. Since the position of the forced engagement or frictional engagement between the container and the supporting structure can be varied easily, the supporting structure of the present invention can be used in a very flexible manner also for containers having different outer dimensions, as long as a sufficient normal force can be ensured for the frictional engagement. The containers can in particular be displaced easily in axial direction in the supporting structure, such that containers of different heights can be held in the same supporting structure. The possibility of axially displacing the containers in the supporting structure also enables an easy compensation of tolerances.

According to the present invention, the receptacles are formed by continuous side walls which shall mean in particular that the respective side walls of the receptacles are not formed by a plurality of pieces, in particular not by two or more side wall portions that can be displaced relative to each other. The sidewalls are actually plate-shaped and formed as a single piece, which is not intended to exclude the possibility that the side walls are coated with a coating, such as with a coating with a high coefficient of friction in order to increase the friction between the side walls of the receptacles and the containers and thus to clamp the containers even more efficiently.

According to the present invention, the opening width or the frictional engagement of all receptacles of the supporting structure can be adjusted by a coordinated adjustment of all of the side walls of the receptacles together. For this purpose all receptacles of the supporting structure are preferably mechanically coupled to each other so that a displacement or deformation of the supporting structure leads to a coordinated adjustment of the opening widths of all receptacles. The coordinated adjustment is designed such that the side walls of the receptacles can be displaced in a coordinated manner between a first position in which the containers can be inserted in the openings or receptacles of the supporting structure with a low force, and a second position, in which the containers are frictionally fixed in the openings or receptacles of the supporting structure.

According to further embodiments, the containers may be processed further while these are received in the supporting structure and in the transport and packaging container. However, if despite all precautions, a container should break, this does not result in a contamination of the whole system, because the rubble but also possible active ingredients or solutions remain in the transport and packaging container.

According to a further embodiment, at least a majority of the bottoms or lower ends of the containers are freely accessible from a bottom side of the supporting structure. Preferably, the bottoms or lower ends of the containers are not covered by any supporting structures or the like. According to further embodiments, however, a holding web or the like may be provided at the lower end of the openings or receptacles of the supporting structure for supporting the bottoms or lower ends of the containers. Thus, an adjusting device, for example an adjusting finger, may act on the bottoms or bottom ends of the containers from the underside of the supporting structure for displacing them axially or for rotating them while they are held in the supporting structure. For example, the containers may be raised suitably in the supporting structure and may be processed further in the raised position while they are supported in the supporting structure, for example they may be provided with an outer closure (beaded cap or crimp). For the adjustment of the position of the container in the supporting structure, according to further embodiments the opening width of the supporting means may be adjusted, in particular the opening width of openings or receptacles of the supporting means as outlined below, so that the frictional engagement is released or substantially reduced at a greater opening width and still persists at a lower opening width for reliably supporting the containers.

The elongated receptacles of the supporting structure for supporting the containers may in principle have a closed or substantially closed bottom, whereupon the bottoms or the lower ends of the containers can be supported. According to preferred embodiments, however, the lower ends of the receptacles are completely open or substantially open. A support on a bottom or supporting web at the bottom end of the receptacles is not absolutely necessary, because according to the present invention the supporting of the containers is accomplished by means of frictional engagement.

The frictional engagement is preferably effected in such elongated receptacles by the interaction of side walls of the receptacles, preferably by diametrically opposite side walls, with portions of the cylindrical side walls or of the neck portions of the containers. For this purpose, the receptacles may have a polygonal cross section, especially a square or hexagonal cross-section. Basically, however, the receptacles may also have a circular or elliptical cross section, such as when supporting webs are provided at the lower ends of the receptacles, which spread apart the side walls of the receptacles when the supporting structure is not locked to a predetermined shape (held taut) by means of latching rails or the like.

A further aspect of the present invention also relates to a transport and packaging container having at least one supporting structure as outlined above and disclosed in further detail in the following.

A further aspect of the present invention relates to a transport and packaging container with measures for protection against plagiarism, especially for identification and/or tracking purposes, as outlined below.

### OVERVIEW ON DRAWINGS

The invention will now be described by way of example and with reference to the accompanying drawings, from which further features, advantages and problems to be solved will become apparent. In the drawings:

FIGS. 1a-1d show a supporting structure and a transport and packaging container according to a first embodiment of the present invention;

FIGS. 1e-1f show in greatly enlarged partial views a variant of the supporting structure according to the above first embodiment;

FIGS. 2a-2c show a supporting structure according to a second embodiment of the present invention;

FIGS. 3a-3c show a supporting structure according to a third embodiment of the present invention;

FIGS. 4a-4e show a supporting structure according to a fourth embodiment of the present invention;

FIG. 5a shows a packaged supporting structure;

FIG. 5b shows a further supporting structure, wherein rim sections can be folded away; and

FIGS. 6a-6b show measures for identification and/or tracking in a transport and packaging container according to the present invention.

In the drawings, identical reference numerals designate identical or substantially equivalent elements or groups of elements.

### DETAILED DESCRIPTION OF PREFERRED EMBODIMENTS

According to the present invention, a supporting structure as well as a transport and packaging container accommodating such a supporting structure are used, as described below, for concurrently supporting a plurality of containers for storage of substances for cosmetic, medical or pharmaceutical applications in an array configuration, in particular in a matrix configuration with regular intervals between the containers along two different directions in space, preferably along two mutually orthogonal spatial directions.

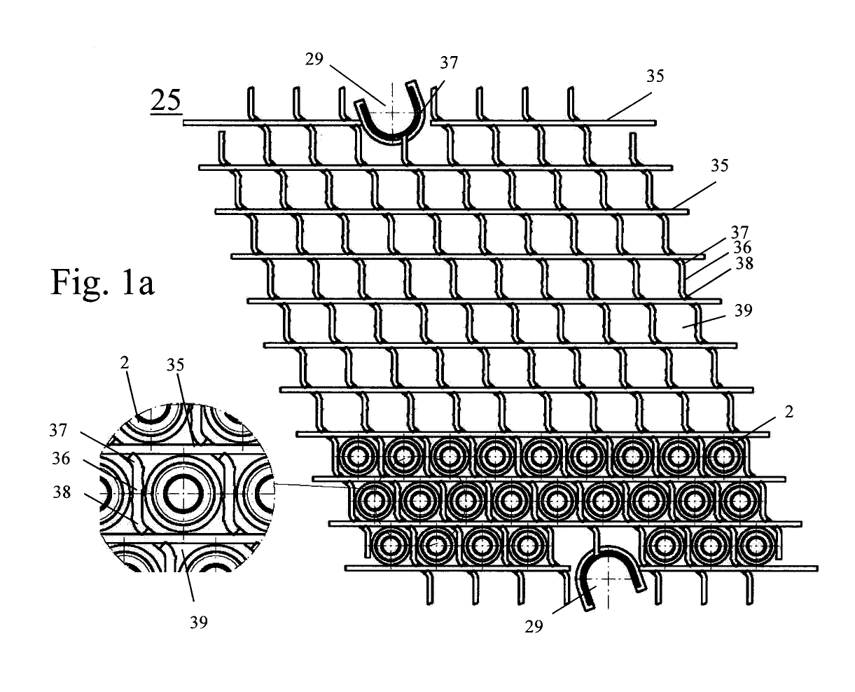

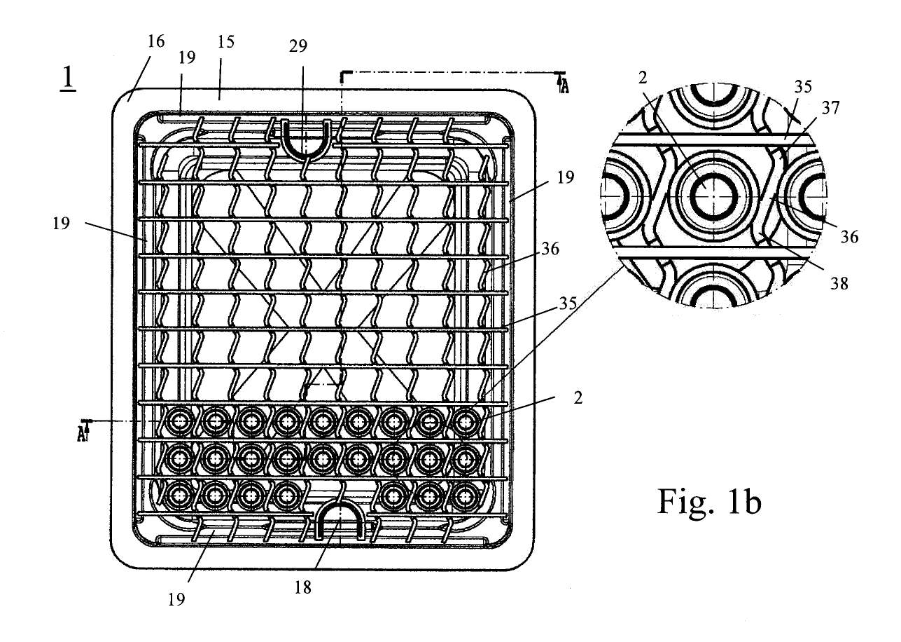

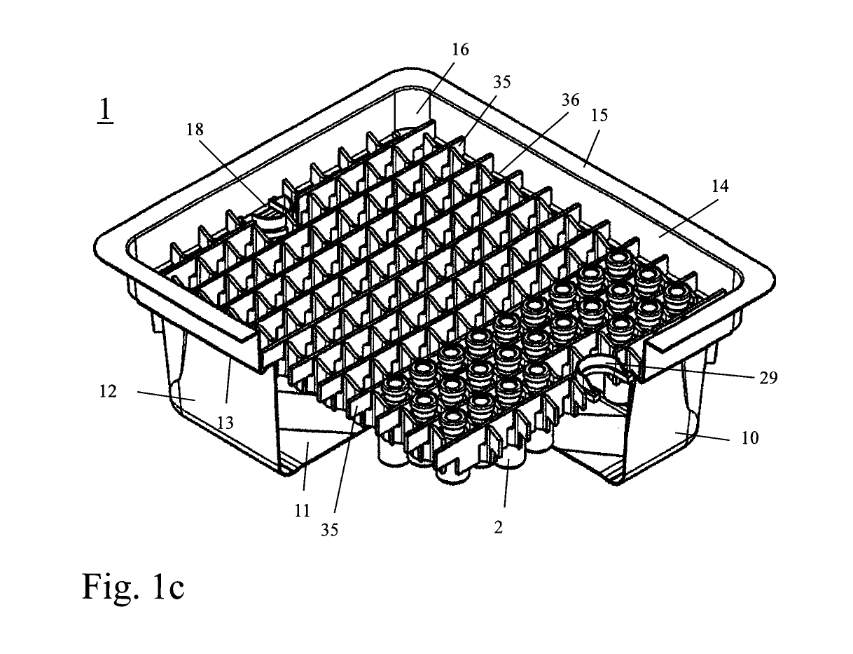

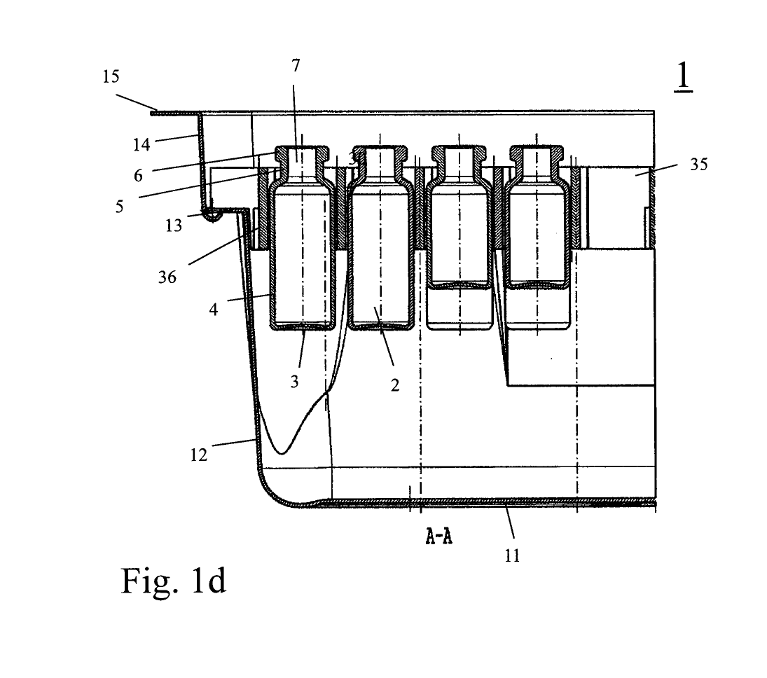

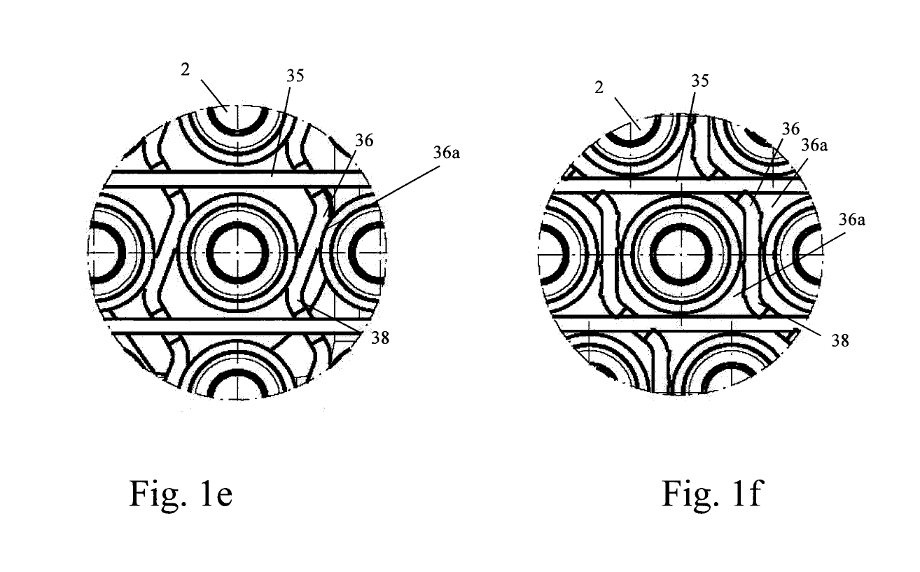

An example of such containers embodied as vials is schematically shown in FIG. 1d in a longitudinal sectional view. The vials have a cylindrical basic shape, having a cylindrical side wall 4 with—within tolerances—constant inner and outer diameters, which project vertically from a flat vial bottom 3, which merges in a constricted neck portion 5 of a relatively short axial length near the upper open end of the vial and then merges in a widened upper rim 6, which has a larger outer diameter than the associated neck portion 5 and is configured for connection to a closure member. The neck portion 5 can be formed with smooth walls and without an external thread or may be provided with an external thread for screwing on a closure member. For example, a stopper (not shown) may be inserted in the inner bore of the neck portion 5 and the upper rim 6, whose upper end is connected with the upper rim 6 of the vial in a gas-tight manner and protected against the intrusion of contaminants into the vial, for example by crimping or beading a metal protective foil which is not shown. Such vials are radially symmetric and are made of a transparent or colored glass or of a suitable plastic material by blow molding or plastic injection molding techniques, and in general can be internally coated so that the material of the vial emits minimal impurities to the agent to be received.

Another example of a medication container according to the present application are ampoules, carpoules, syringes or injection containers. Ampoules or carpoules are containers for medication agents for usually parenteral administration (injection), for cosmetics and other agents and are usually cylindrical in shape with an extended tip (spear or head) and a flat bottom or also with two extended tips at both ends. These may be formed in particular as snap-off ampoules with an annular predetermined breaking point around the ampoule neck or as an OPC cartridge (OnePoint-cut ampoule) having a breaking ring inscribed into the glass. Syringes or injection containers, also known as injection flask, vial or reusable ampoule, are cylindrical containers of glass or plastic shaped similar to a bottle, usually having a relatively small nominal volume (e.g. 1 ml, 10 ml). They are sealed with a rubber plug with septum (puncture rubber). For protecting the septum and fixing the rubber plug an outer closure (beaded cap or cramp), often made from an aluminum sheet, is necessary. In a carpoule the liquid is stored in a cylinder, which is closed at one end by means of a thick rubber or plastic plug. This acts as a piston when the content is pressed out using a carpoule syringe. At the other end the cylinder is closed only by means of a thin diaphragm, which is pierced from the rear end of the carpoule syringe (a cannula sharpened on both sides) in the application. Cylindrical ampoules are often used in dentistry for local anesthesia. Special cylindrical ampoules with a specially shaped front part (e.g. thread) are used for insulin therapy in insulin pens.

In the sense of the present invention, such containers are used for storage of substances or agents for cosmetic, medical or pharmaceutical applications, which are to be stored in one or several components in solid or liquid form in the container. Especially in the case of glass containers storage periods can amount many years, notably depending on the hydrolytic resistance of the glass type used. While, in the following, cylindrical containers are disclosed, it should be noted that the containers, in the sense of the present invention, may also have a different profile, for example a square, rectangular or polygonal profile.

Inevitably such containers have tolerances due to the production which can be of the order of one or several tenths of a millimeter in particular for glass containers. To compensate for such manufacturing tolerances, while ensuring that all bottoms 3 or bottom ends of the containers can be disposed in a plane, according to the present invention the containers are fixed by means of a frictional fit or clamping on a supporting structure. This frictional fit is implemented either in the region of the cylindrical side wall 4 or at the bottom closed end or bottom of the containers or in accordance with other preferred embodiments in the region of the constricted neck portion 5. In the latter case, at least the great majority of the containers is frictionally supported in the region of the constricted neck portion 5, which, however, according to further embodiments is not intended to exclude that in individual containers with large manufacturing tolerances with respect to their axial length the transition region between the upper rim 6 and the constricted neck portion 5 exceptionally may also be engaged behind or supported in positive fit manner.

For concurrently supporting a plurality of containers, a supporting structure 25 (also referred to as a “nest” in the prior art) is provided, which will be explained hereinafter with reference to FIGS. 1a to 1c and which is formed of a plastic material, e.g. by injection-molding. The supporting structure 25 comprises a plurality of receptacles 39 that extend in the longitudinal direction of the containers 2 to be accommodated and which are coupled with each other. Preferably, the receptacles 39 are also coupled mechanically with each other. The side walls of the receptacles 39 are sufficiently flexible and expandable so that the containers 2 can be inserted from above or from below into the receptacles 39. Thus, a plurality of containers 2 may be supported by friction or may be clamped. Due to the elasticity of the side walls of the receptacles also manufacturing tolerances in the axial and/or radial direction of the containers may be compensated, in particular in the case of medication containers of glass. In particular, containers having different diameters may also be supported by one and the same supporting structure 25 by friction.

For the transport and packaging of a supporting structure in the sense of the present application with the containers accommodated therein a transport and packaging container 10 (referred to as “tub” in the prior art) is used as schematically shown in FIG. 1c. According to FIG. 1c, the container 10 is substantially box-shaped or tub-shaped and has a base 11, a circumferential side wall 12 protruding in vertical direction therefrom, a step 13 protruding substantially rectangular therefrom, a circumferential upper side wall 14 and an upper rim 15 which is formed a flange. The corners 16 of the container 10 are suitably formed rounded. The upper side wall 14 may be formed inclined at a small angle of inclination with respect to the vertical to the base 11 in order to ease the insertion of the supporting structure 25. Such a transport and packaging container 10 is preferably formed from a plastics material, particularly by plastic injection molding, and is preferably formed of a clear transparent plastic in order to enable a visual inspection of the supporting structure 25 received in the transport and packaging container 10 and of the containers 2 supported by it.

For receiving the supporting structure 25 in the transport and packaging container 10, the supporting structure 25 may be surrounded by a holding frame which has a supporting web which is formed closed. The supporting structure 25 shown in FIG. 1c generally may also be clamped in a supporting frame or be clamped along the edge or may be integrally formed with such a supporting frame. For a reliable positioning of the supporting structure 25 in the container 10, the supporting structure 25 and the containers 10 may have positioning structures that cooperate with each other, in particular in a positive-fit manner. Thus, positioning structures in the form of projections or recesses or depressions may be formed at an appropriate position, in particular on the step 13 or on the supporting surfaces 18 of the container 10, which co-operate in a positive-fit manner with corresponding recesses or depressions or projections of the supporting structure for precisely positioning the supporting structure 25 in the transport container 10. To this end, a plurality of pin-like protrusions may be formed on the step 13 which engage in corresponding centering openings formed in the supporting structure. According to FIG. 1c the step 13 of the transport container 10 is formed as a circumferential, flat supporting surface on which the supporting structure 25 is directly supported. According to further embodiments also additional supporting surfaces or supporting elements, in particular in the form of protrusions, may be formed on the side walls 12 of the transport container 10, as described below. In this manner, the supporting structure 25 can be positioned precisely in the transport container 10 and thus the plurality of containers 2 can be positioned and held in a regular array and at precisely defined positions in a transport container 10 with standardized dimensions. In particular, it can be ensured in this way that all bottoms of the containers are positioned in a plane defined jointly and parallel to the base 11 or to the upper rim 15 of the transport container 10.

Although the bottom 11 of the transport container 10 is shown in FIG. 1c to be closed and formed integrally with the side wall 12, the lower end of the transport container 10 may also be formed open in the manner of the upper end, in particular with a flange-like bottom rim in the manner of the upper rim 15 so that the bottoms of the containers are freely accessible from the underside of the transport container 10, e.g. for processing steps in a sterile tunnel or in a freeze-dryer, as explained in detail below.

As shown in FIG. 1c, in the array configuration according to FIG. 1c, the plurality of containers 2 are supported distributed along two mutually orthogonal directions in a plane and at predetermined constant intervals. In principle, also other regular arrangements are conceivable, e.g. rows or columns of containers 2 may also be disposed offset to each other by a predetermined length, namely in a periodic configuration having a predetermined periodicity. Thus, automated processing systems may expect the containers 2 at precisely predetermined positions upon their transfer to a processing station, which significantly reduces the efforts required for automation. As explained in more detail below, according to the present invention the containers 2 may also be processed further jointly while being within the supporting structure 25 or the transport container 10, especially also in a sterile tunnel or a freeze-dryer.

For enabling an easy insertion of the supporting structure 25 into the container 10 and removal from the latter, access apertures 29 are formed on two longitudinal sides of the supporting structure 25, via which gripping arms or the like may grab the supporting structure 25. As can be seen in FIG. 1c, the access apertures 29 are offset from one another by a row which further facilitates an unambiguous positioning of the supporting structure 25 in the transport container 10.

FIG. 1b shows a plan view of the packaging unit 1 according to FIG. 1c. FIG. 1d shows a longitudinal sectional view along the line A-A according to FIG. 1c.

FIG. 1a shows a supporting structure 25 according to a first embodiment according to the present invention. It comprises a plurality of transverse webs 35, which extend in parallel with each other and which are connected to each other via S-shaped connecting webs 36, which are disposed at regular intervals extend substantially perpendicularly to the transverse webs 35. More specifically, the connecting webs 36 are connected with the transverse webs 35 via front and rear ends 37, 38, respectively, which are curved over in opposite directions. The connecting webs 36 are made of a plastic, preferably from a flexible plastic. The transverse webs 35 preferably have a greater stiffness than the connecting webs 36. Due to the S-like shape of the connecting webs 36, the transverse webs 35 are offset to each to each other in the longitudinal direction by a constant distance, so that the supporting structure 35 is configured overall as a parallelogram having a basis in the region of the lower rim of the supporting structure 25 shown in FIG. 1a and two imaginary lines extending at an acute angle, which connect the front ends of the transverse webs 35 with each other. In the relaxed home position shown in the right-hand part of FIG. 1a the containers 2 can be inserted into the elongated holding receptacles 39 formed by the webs 35, 36 freely and without contact with the webs 35, 36, or at least with minimal forces. The supporting receptacles 39 have essentially a square-shaped cross section which is matched to the diameter of the containers 2 such that these may be fixed therein, and in particular can be clamped therein, with a sufficient frictional force in a second position of the supporting structure 25.

For converting the supporting structure 25 from the first position shown in FIG. 1a into the second position shown in FIG. 1b, the transverse webs 35 may be shifted respectively in their longitudinal direction so that, finally, the square-shaped or quadratic supporting structure 25 shown in FIG. 1b is formed. As can be derived from the comparison of FIGS. 1a and 1b, the connecting webs 36 are slightly bended for this purpose. The second position according to FIG. 1b can be fixed by means of the cooperation of the access apertures 29 formed in the supporting structure 25 with correspondingly shaped counter-elements of the container 10 or by means of the cooperation of centering openings with correspondingly shaped centering pins of a supporting frame, not shown, which accommodates the supporting structure 25.

As can be concluded from the enlarged partial view shown in FIG. 1a, the containers 2 are loosely accommodated in the supporting receptacles 39 in the first position according to FIG. 1a. As can be concluded from the enlarged partial view according to FIG. 1b the containers 2 are frictionally fixed, in particular clamped, by central portions of the connecting webs 36 in the second position shown in FIG. 1b. A certain clearance to the transverse webs 35 may persist, which, however, is preferably minimum or vanishing.

FIG. 1c shows the packaging unit 1 formed in this way in a perspective partial section, wherein it can be seen that in this embodiment the transverse webs 35 are directly supported on the supporting surface formed by the step 13 of the container 10. The frictional fixation of the containers is visible in the partial section of FIG. 1d.

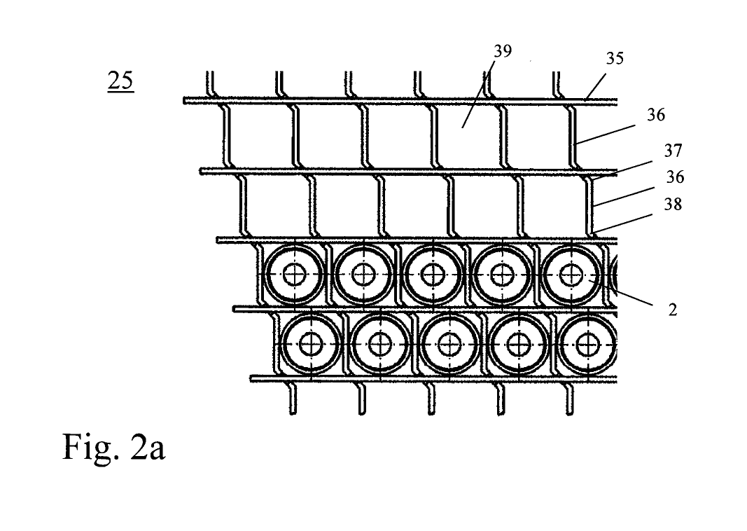

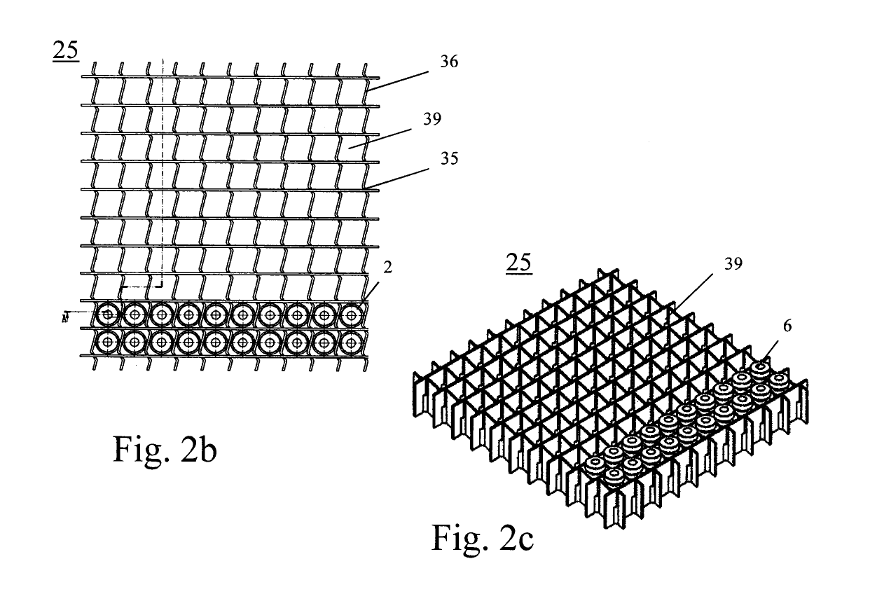

FIGS. 2a to 2c show the supporting structure according to a further embodiment in a schematic plan view and a perspective view in the above-mentioned second position.

As stated above, in the first embodiment described above all the side walls of the receptacles 39 are adjusted in a coordinated manner, i.e. jointly, from the first position to the second position upon displacement of the transverse webs 35, namely by pivoting of the upper end of the supporting structure 25 (see FIG. 1a) relative to the base at the lower end of the parallelogram shown in FIG. 1a. Thus, the containers can be inserted into the supporting structure and accurately positioned in the afore-mentioned first position, in particular at a predetermined height level and such that all the bottoms of the containers are arranged and aligned in a common plane. All containers are then concurrently frictionally fixed by coordinated adjustment of the supporting structure into the afore-mentioned second position and are precisely positioned in a regular array. The supporting structure according to FIGS. 1a to 1c is preferably formed integrally of a plastic.

FIGS. 1e and 1f show in greatly enlarged partial views a further version of the supporting structure according to FIGS. 1a-1d. FIG. 1e shows the portion of a receptacle of the supporting structure in the afore-mentioned second position, in which the containers 2 are supported in the receptacles of the supporting structure. Differing from FIGS. 1a-1d in this embodiment a respective concave portion 36a is formed at the connecting webs 36 at the two sides, wherein the radius of curvature of both concave receptacles of the portions 36a is matched to the radius of the containers 2. In the second position according to FIG. 1e, in which the connecting webs 36 extend inclined relative to the transverse webs 35, the concave receptacles 36a nestle to the cylindrical side walls of the container 2, so that the containers can be held more reliably and more precisely. In the first position according to FIG. 1f, in which the connecting webs 36 extend perpendicular to the transverse webs 35, the concave receptacles 36a are not disposed anymore opposite to the cylindrical side walls of the containers 2 so that the containers may be inserted into the receptacles formed by the webs 35, 36 without hindrance, or at least with a significantly reduced force, and removed therefrom. Ideally, the webs 35, 36 do not abut to the side walls of the containers 2 in the first position according to FIG. 1f.

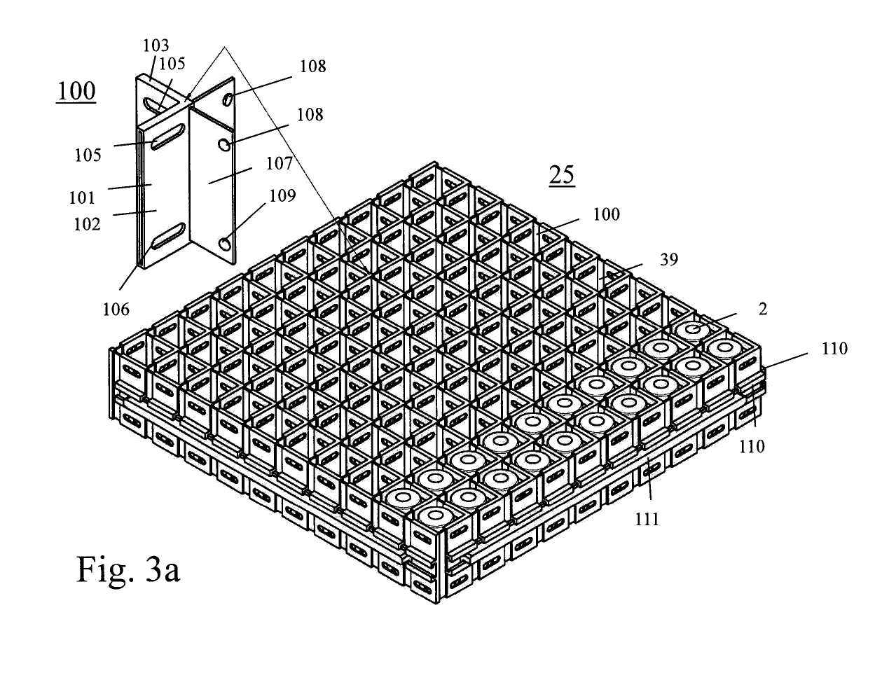

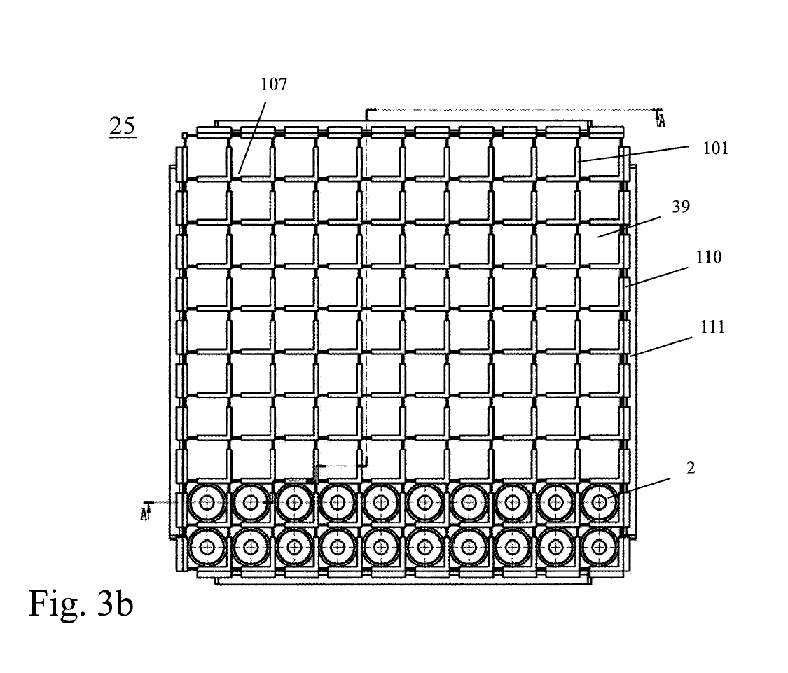

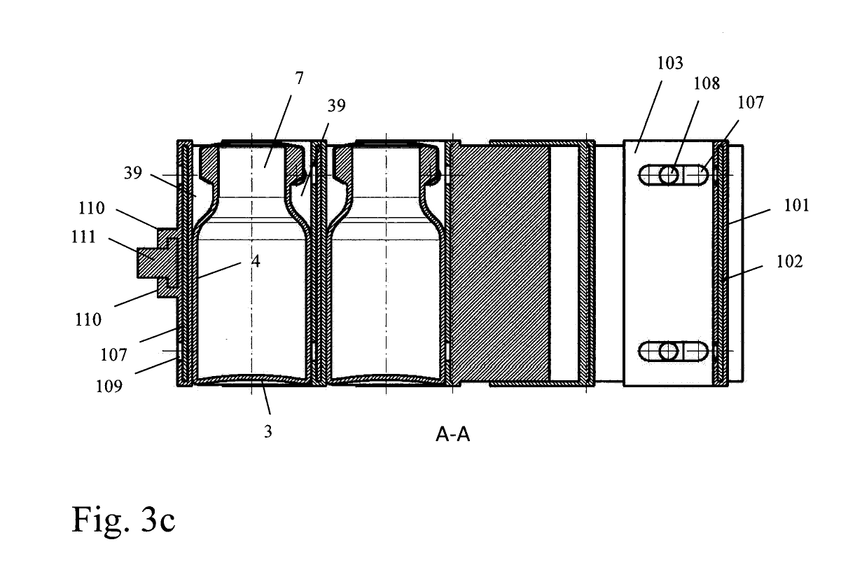

A supporting structure, similar to that described above with reference to FIGS. 1a-1f, may be stuck together from a plurality of identical base units as described below with reference to FIGS. 3a-3c.

According to the upper part of FIG. 3a, a base unit 100 comprises side walls 101, 103, 107 which have identical leg lengths and intersect each other perpendicularly. Two of the side walls, namely the side walls 101, 103, are slit, having a longitudinal slot 102, which extends substantially over the entire height of the side walls 101, 103. An upper long hole 105 and a lower long hole 106 extending in parallel with each other are formed in the side walls 101, 103. The thickness of the side walls 107 is matched to the width of the longitudinal slot 102 such that they can be accommodated therein. Cylindrical protrusions 108, 109 are formed on the side walls 107, which are guided in the upper and lower long hole 105, 106, when the side walls 107 are inserted in the associated longitudinal slot 102. A plurality of such base units 100 is stuck together to a rectangular supporting structure 25, as shown in the lower right-hand part of FIG. 3a.

FIG. 3b shows the supporting structure 25 according to FIG. 3a in a schematic plan view. The side walls 101 of the base units serve as guide plates for the latching plates 107 of the base units accommodated therein. Because of the co-operation of the projections 108, 109 with the associated long holes 105, 106, the base units are mounted displaceably in the plane of the supporting structure 25. Because of the co-operation of the base units thus a plurality of substantially square-shaped or rectangular elongated receptacles 39 are formed, into which the containers 2 can be inserted from above or from below. For insertion of the containers, the base units are spread apart such that the opening widths of the receptacles 39 allow an unimpeded insertion of the containers or at least an insertion of the containers with minimum force. Then all the base units can be pressed against each another in a coordinated manner so that the containers 2 accommodated in the receptacles 39 are finally fixed, in particular clamped, with sufficient frictional force. Also in this embodiment it can be accomplished that all bottoms of the containers 2 are freely accessible from the underside of the supporting structure 25 and are arranged in a common plane. FIG. 3c shows the supporting structure 25 according to FIG. 3b in a partial longitudinal section along line A-A of FIG. 3b.

The rectangular basic shape of the supporting structure 25 is achieved in this embodiment by the form-fitting elements 110 having an L-shaped profile, which are disposed on the outer walls of the outer base units, so that an essentially U-shaped receptacle having a longitudinal slot is formed in the base, into which the latching rail 111 is engaged, which is provided with a corresponding T-shaped profile. By means of the latching rail 111 also a fixation of the positions of all the base units 100 may be accomplished, for example by screwing or clamping of the latching rail 111 in any case to the front and rear base units 100 of a column or row of the matrix-shaped supporting structure 25.

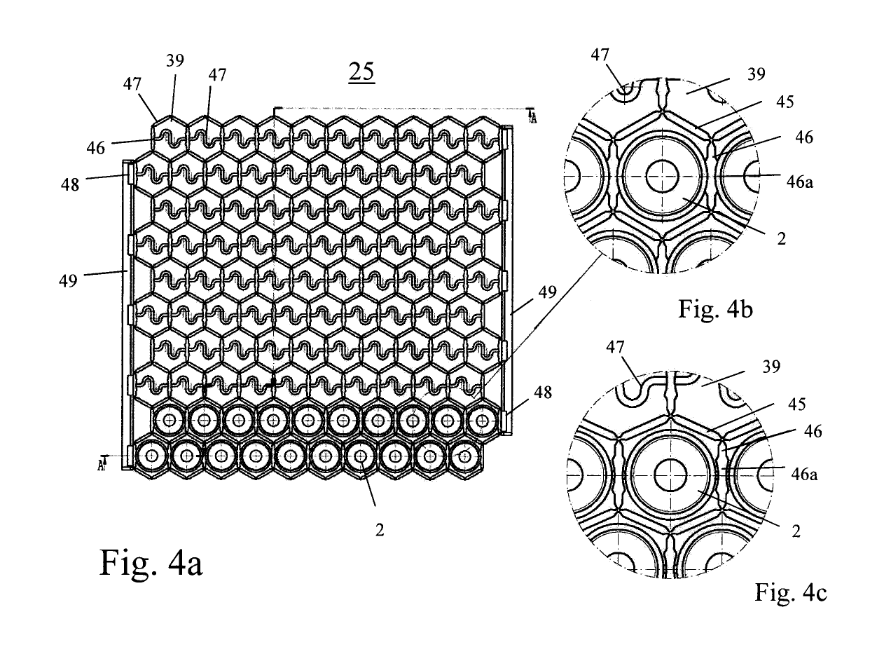

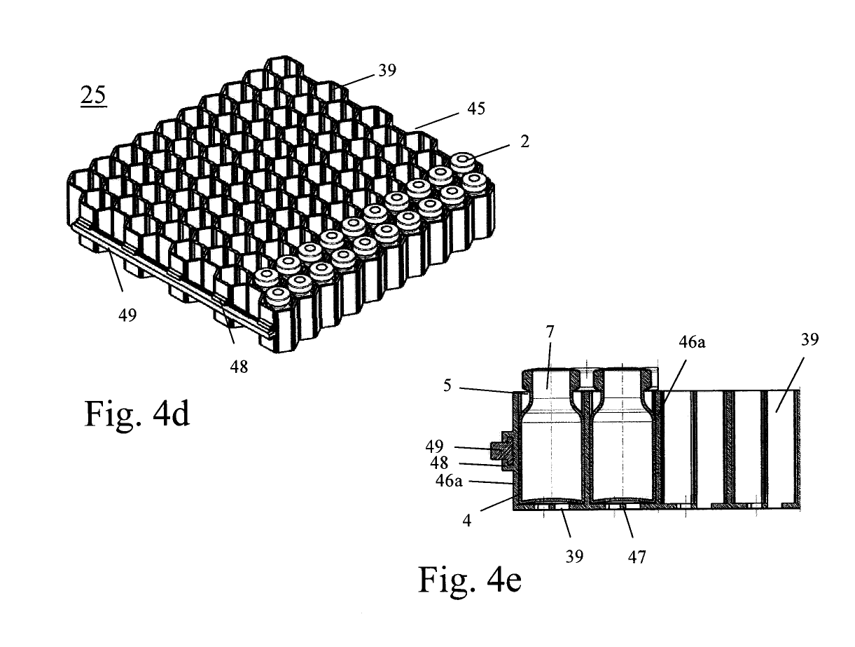

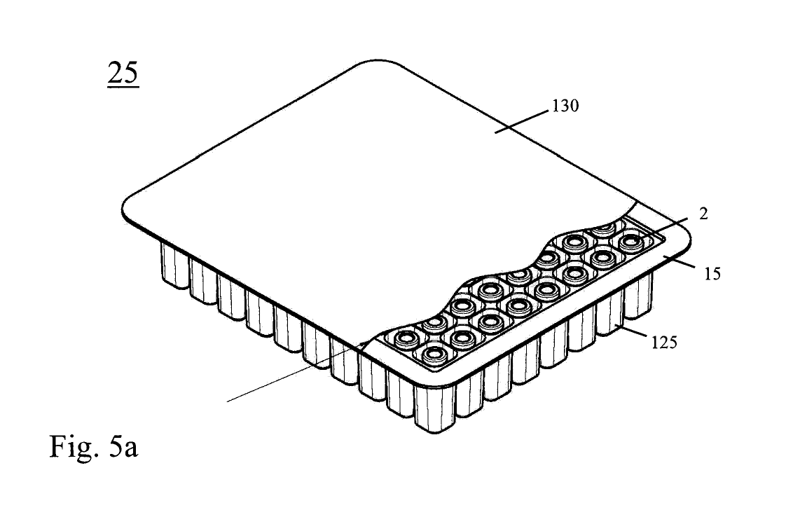

FIGS. 4a to 4e show a supporting structure 25 according to a further embodiment. This is formed by a plurality of hexagonal receptacles 39 for accommodating containers 2, wherein the rows of hexagonal receptacles are arranged alternately and offset to each other. The hexagonal receptacles 39 are formed by two pairs of side walls 45 converging at an obtuse angle which are connected with each other via flexible clamping webs 46. As can be concluded from FIG. 4b, each of the flexible clamping webs 46 comprises a concave holding portion 46a, wherein the connecting webs 47 are formed mirror-symmetrically, so that the concave indentations on both sides of the clamping webs 46 face the side walls of the associated containers 2. At the lower end of the supporting receptacles 39 wave-shaped webs 47 connect the two clamping webs 46a with each other. The webs 47 may be used as supporting webs for supporting the containers 2 accommodated in the receptacles 39. As an alternative, the webs 47, may bias respective opposite side walls of the receptacles 39 elastically towards each other so that containers with different diameters can be clamped easily. The supporting structure 25 according to FIG. 4 can in principle be injection molded as one piece from a plastic. However, according to other embodiments the supporting structure 25 may also be composed of a plurality of honeycomb-shaped base units, which are produced individually and assembled in the configuration shown, and which are held together in this configuration by means of latching rails 49, as described below.

The wave-shaped webs 47 press the receptacles 39 of the supporting structure 25 in the illustration of FIG. 4a laterally apart, so that the clamping webs 46 with their indentations 46a are pressed against the circumferential sidewalls of the containers 2 in the first position shown in FIG. 4c so that the containers 2 are accommodated with sufficient holding forces in the receptacles 39, as shown in the insert according to FIG. 4b. For transferring this supporting structure 25 starting from the position shown in FIG. 4b into second position shown in FIG. 4c in which the clamping webs 46 with their indentations 46a do not clamp anymore the circumferential side walls of the containers 2 or at best only with a small force, so that the containers may removed from the receptacles without much effort or so that they can be displaced therein, the supporting structure 25 must be pulled apart in transverse direction in the illustration of FIG. 4a. For this purpose, form-fitting elements 48 having an L-shaped profile are formed on the outer walls of the outermost hexagonal receptacles 39, which form T-shaped receptacles, into which a correspondingly shaped latching rail 49 is inserted. By pulling these latching rails in the transverse direction, the supporting structure can be spread and at the same time all receptacles 39 are expanded. Depending on how much one pulls laterally at the latching rails 49, the receptacles 39 can be suitably expanded. The latching rails 4d shown in FIG. 4d may be fitted in a lateral holding frame or be supported on a supporting surface of a transport and packaging container. Thus, by compression of the receptacles 39 overall the opening widths of the receptacles 39 may be transferred in a coordinated manner from the first position according to FIG. 4c to the second position according to FIG. 4b, in which the containers 2 are frictionally fixed at predetermined positions. The height level of the containers 2 is here defined essentially by the webs 47 because the bottoms of the containers 2 are supported on the webs 47. As can be concluded from the sectional view of FIG. 4e, the majority of the bottoms of the containers 2 is freely accessible from below, for example, for a mechanical adjusting device.

While it has been stated above that the supporting structure is supported on the supporting surface formed the step 13 near the upper rim, it can in principle also be supported directly on the base 11 of the transport container 10. This works in principle for all types of supporting structures having a certain axial length, be it that the bottoms of the containers 2 rest directly on the base 11 of the container 10 or on bottoms of the elongate receptacles 39 of the supporting structure 25

While it has been stated in the previous embodiments, that the containers are placed upright and with their open ends facing towards the transport and packaging container, the containers can also generally be reversed, i.e. pointing to the bottom of the transport and packaging container with their open ends.

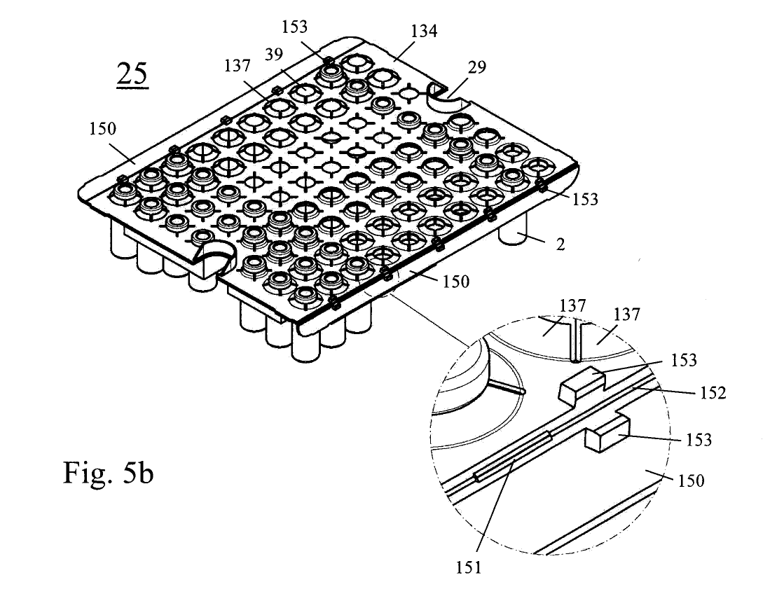

The top or the top and underside of a supporting structure 25 of the present invention, or of a transportation and packaging container 1 according to the present invention, may be covered with a sterile, gas-permeable protective film which is adhered and may be removed if necessary. This is shown in FIG. 5a as an example for a supporting structure 25 for which it is shown that the film 130 is bonded to the upper rim 15, wherein further details of a (in this case positive-fit) support of the containers 2 will not be discussed further. The protective film may be in particular a gas-permeable plastic film, in particular a web of synthetic fibers such as polypropylene fibers (PP) or a Tyvek® protective film, which enables a sterilization of the containers 2 accommodated in the supporting structure 25 through the film 130.

In all embodiments of the invention, antimicrobial powders may be added to the plastic of the supporting structure (of the carrier) and/or of the transport and packaging container. Antimicrobial powders with atoms or ions, such as, for example, Ag, Zn, Cu, Ce, Te, or I, are suitable for various purposes as aggregate or filler because of their biocidal, bactericidal and fungicidal effect. The biocidal effect occurs, for example against bacilli, fungi, viruses, yeasts, algae and other microorganisms. Powders having a biocidal effect may be added to the plastic of the supporting structure (the carrier) and/or to the transport and packaging container in particular s glass powder, which contain the Ag₂O, CuO, Cu₂O, TeO₂, ZnO, CeO₂ and I. For use in plastics, the mechanical and optical characteristics remain largely unchanged. The powder may be added either already as nanopowders, for example, to the plastic powder mixtures during injection molding or to paints during deep-drawing processes. An antimicrobial effect can also be achieved when the plastic is provided with an antimicrobial coating containing the above-mentioned powder.

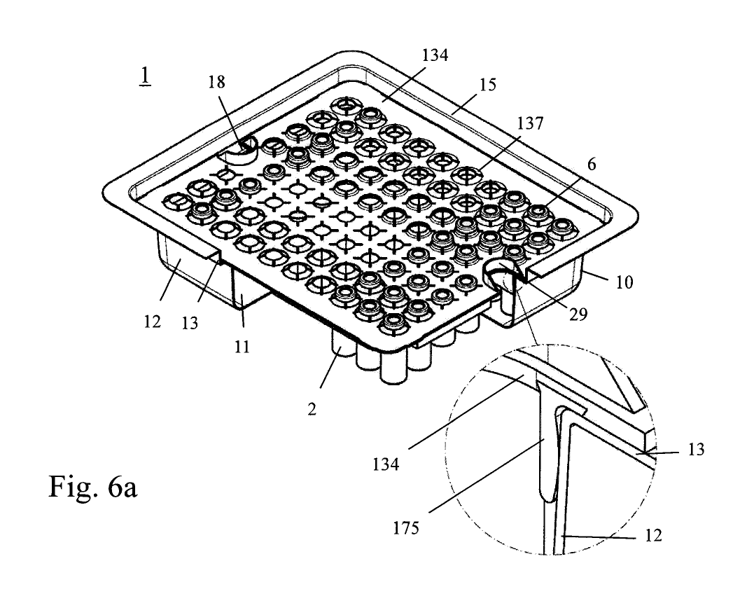

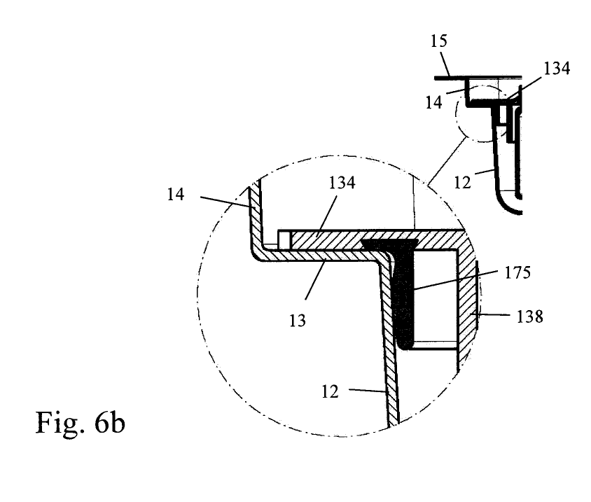

FIGS. 6a and 6b show a further embodiment of a packaging unit 1 with a holding plate 134 received in the transport and packaging container 10 in which a plurality of containers 2 are fixed by friction by means of ring elements 137. The packaging unit 1 comprises measures for identifying and/or tracking as follows: as shown in the enlarged insert of FIG. 15a, an electronic wirelessly readable RFID chip or RuBee chip 175 (a RuBee chip transmits at frequencies that can penetrate metal and water) is disposed in the region of the access aperture 29 between the supporting plate 134 and the side wall 12 and/or the step 13 of the container 10, which can be read out in a contact-less manner through the side walls of the packaging unit 1 and outputs information with regard to identity, important product characteristics (manufacturer, content, production date, expiry date, . . . ) if queried. The chip 175 may be glued into the packaging unit 1 at a suitable position, also at a different position than shown in the figure. The chip 175 may be arranged such that in the case that the packaging unit 1 is opened or that the supporting plate 134 is taken out of the packaging unit 1, the chip 175 is destroyed, for example is broken or getting inoperative. Due to lack of response from the chip 175 to a radio query an information is therefore available, which indicates that the packaging unit must have been manipulated in some way since the previous packaging process. Because the chip 175 does not respond to the radio query. This can for example be used to prove the authenticity and integrity of the packaging unit and the containers accommodated therein.

According to a further preferred embodiment the RuBee chip or RFID chip 175 is integrated in combination with other sensors that can monitor the important parameters of the transport and packaging container 1 as a function of time, the important quality or authenticity characteristics relating to containers accommodated in the transport and packaging container 1. These quality or authenticity characteristics can be recorded periodically and be stored in a memory associated with the chip or sensor. For supplying these electronic components with electric power an independent power supply may be provided in the transport and packaging container 1, in particular a battery of small dimensions or also inductively via a small wire loop. The following sensors are particularly conceived according to the present application:
a moisture sensor with or without a memory (data logging) which periodically measures the humidity prevailing in the transport and packaging container and records it, if required;
a gas sensor with or without a memory (data logging), which measures the concentration of gases in the transport and packaging container such as O₂, ozone, CO₂ or sterilization gases such as Ethylene oxide, formaldehyde, and records it, if required;
a temperature sensor with or without a memory (data logging), which periodically measures the temperature prevailing in the transport and packaging container and records it, if required;
an UV sensor with or without memory (data logging), which periodically measures UV radiation entering the transport and packaging container and records it, if required;
a gamma ray sensor, electron beam sensor or X-ray sensor with or without memory (data logging), which periodically measures radiation entering the transport and packaging container and records it, if required;

Furthermore, further measures can be taken in the transport and packaging container relating to a plagiarism protection and reliable proof of the authenticity and originality of the vials stored in the transport and packaging container. For this purpose, in particular a luminescence-based plagiarism protection may be provided, namely in the form of luminescent substances coated at a suitable place in or on the transport and packaging container that are conventionally referred to also as “phosphors”. The luminescent substances, which are preferably invisible to the human eye, can, however, be distinguished based on different spectral emission spectra in a characteristic manner. The luminescent substances are preferably composed of inorganic luminescent materials (for example, microcrystals, nanocrystals and/or quantum dots), which fluoresce and/or phosphoresce at specific wavelengths. The different types of luminescence are classified according to the duration of luminescence after the excitation in fluorescence (<1 msec) and phosphorescence (≧1 ms).

The emission wavelengths may have a narrow spectral width (for example, InBO₃:Eu or Tb) and/or also emit broadly (Ce:YAG). The spectral position depends on the composition and/or the concentration of the luminescent substances. Preparation is accomplished by mixing the luminescent substances with plastic granules, plastic powder, solvents or paints before being processed further (injection molding, deep-drawing, . . . ). Also, organic luminescent materials may be applied.

Thus it is possible to produce various packaging batches which have characteristic emission spectra, the emission lines of which depend on the concentration used and on the combination of fluorescent materials (for example, oxides, oxynitrides, nitrides, sulfides, fluorides, . . . ) and differ with regard to the wavelength and intensity ratios. The luminescent materials may for example be composed of different Eu-doped materials, such as CaS: Eu: Eu, Sr₂Si₅N₈:Eu, SrS:Eu, Ba₂Si₅N₈:Eu, Sr₂SiO₄:Eu, SrSi₂N₂O₂:Eu, SrGa₂S₄:Eu, SrAl₂O₄:Eu, Ba₂SiO₄:Eu, Sr₄Al₁₄O₂₅:Eu, SrSiAl₂O₃N:Eu, BaMgAl₁₀O₁₇:Eu, Sr₂P₂O₇:Eu, SrB₄O₇:Eu, Y₂O₃:Eu, YAG:Eu, Ce:YAG:Eu, (Y, Gd)BO₃:Eu, (Y,Gd)₂O₃:Eu. Luminescent materials may be co-doped or may be doped with other rare earth elements (scandium, yttrium, lanthanum, cerium, praseodymium, neodymium, promethium, samarium, gadolinium, terbium, dysprosium, holmium, erbium, thulium, ytterbium and lutetium) (e.g. LaPO₄:Ce, Tb, LaMgAl₁₁O₁₉:Ce, Tb, (Y, Gd, Tb, Lu)AG:Ce, Lu_{3-x-y-z}AₓAl_{5-y-z}Sc_{y}O₁₂:Mn_{z}Ca_{z}, Lu₂SiO₅:Ce, Gd₂SiO₅:Ce, Lu_{1-x-y-a-b}YₓGd_{y})₃ (Al_{1-z}Ga)₅O₁₂:CeₐPr_{b}). Cheap luminescent materials for VUV excitation are LaPO₄:Pr, YPO₄:Pr, (Ca,Mg)SO₄:Pb, LuBO₃:Pr, YBO₃:Pr, Y₂SiO₅:Pr, SrSiO₃:Pb, LaPO₄:Ce, YPO₄:Ce, LaMgAl₁₁O₁₉:Ce. In the case of excitation with X-rays as an example the following luminescent materials are used: InBO₃:Tb+InBO₃:Eu, ZnS:Ag, Y₂O₂S:Tb, Y₂SiO₅:Tb, Y₃(Al,Ga)₅O₁₂:Ce, (Zn,Cd)S:Cu, Cl+(Zn,Cd)S:Ag, Cl, Y₃(Al, Ga)₅O₁₂:Tb, Zn₂SiO₄:Mn, Zn₈BeSi₅O₁₉:Mn, CaWO₄:W, Y₂O₂S:Eu+Fe₂O₃, (Zn,Mg)F₂:Mn, Y₃Al₅O₁₂:Tb.

Purely mathematically thus several 100 billion fluorescent variants can be generated. Identification is possible with simple hand spectrometers.

An extension of the counterfeit protection can be achieved if certain emission spectra are used to excite other luminescent materials. I.e. the excitation takes place for example by means of UVCradiation (for example, wavelength=254 nm). The luminescent material emits at UVA (e.g., wavelength=450 nm), which enables other luminescent materials to be excited. Furthermore, one may obtain a time characteristic fingerprint based on the emissions, which are different in time (decay time). Also by the use of isotopes partly spectral isotope shifts can be obtained, which can be detected optically. As a result, several trillion combinations are possible. Thus, in particular, invisible fluorescent labels can be implemented in and on the transport or packaging container with excitation spectra in the X-ray spectrum (10 pm-1 nm), extreme ultraviolet (1 nm 100 nm), VUV (100 nm-200 nm), UVC (200 nm-280 nm), UVB (280 nm-320 nm), UVA (320 nm-400 nm) and/or in the blue spectral range (400 nm-480 nm). The excitation can be implemented by means of various light sources, such as X-ray tubes, lasers, LEDs, halogen lamps and/or CCFLs (cold-cathode lamps) continuously or in a pulsed manner and/or in a combination thereof. The emission spectra of the fluorescent labels may be in the UV and visible spectral range (VIS) and/or in the infrared spectral region (NIR and/or MIR). The detection can be performed with a commercially available spectrometer and or in a time-resolved manner, for example by using a boxcar amplifier to measure the time decay of the emission in a time-resolved manner by means of a detection in a time window and/or at two different times in the time interval. The time interval may be, for example, a few ns to a few ms and should be longer than the turn-off time constant of the light source. Various pigments (e.g. nanocrystals) may also be combined that fluoresce at different times, places and/or spectral positions. Furthermore, the luminescent labels can also be arranged in the form of 1D barcodes (e.g. EAN, UPC, IAN, JAN) and/or 2D bar codes (e.g. QR, DataMatrix, Maxi, point) and/or as a composite code. The barcodes can either be patterned directly on the package with e.g. a screen printing method, inkjet printing or a spraying method using a particular template or indirectly be stuck on labels (plastic or paper). Also, the application of a plurality of additive or patterned luminescent layers is possible.

The holding force respectively exerted by the frictional-type holding means on the containers is sufficient to hold the containers reliably on the supporting structure. Particularly, the holding force applied is greater than the weight of the containers, optionally including the content and sealing stopper. According to further to embodiments, the holding force be configured by manes of an appropriate design of the holding means such that it is greater than the standard forces during handling, processing or treatment of the containers in a process plant. Thereby a reliable holding of the containers is always ensured. However, according to further preferred embodiments of the invention the containers are displaced in the openings or receptacles despite the holding force, in particular displaced in axial direction or rotated. The force required for this only needs to be greater than the force exerted by the holding means.

Of course, the supporting structure (the carrier) in the sense of the present invention may also formed of a thermoplastic, thermosetting or elastomeric plastic material, wherein at least portions of the supporting structure or of the carrier are provided with a coating reducing friction to facilitate the insertion and removal of the containers.

According to a further embodiment, the supporting structure and/or transport container, or portions thereof, may be formed of fiber reinforced plastics or of a plastic to which ceramics or metals are added in order to increase its thermal conductivity. As is known, fiber reinforced plastics have a higher thermal conductivity of up to 0.9 W/(m K) if including carbon fibers. If ceramics or metals are added to the plastics, the thermal conductivity is further increased. Thus so-called heat-conductive plastics are created. Thus, a thermal conductivity of 20 W/(m K) is accomplished.

It will be readily apparent for the person skilled in the art upon reading the above description that the various aspects and features of the embodiments described above may be combined in any manner with one another, resulting in numerous further embodiments and modifications. It will be readily apparent for the person skilled in the art upon reading the above description that all such further embodiments and modifications shall be comprised by the present invention, as long as these do not depart from the general solution and scope of the present invention, as defined in the appended claims.

What is claimed is:

1. A supporting structure for concurrently holding a plurality of cylindrical containers for substances for medical, pharmaceutical or cosmetic applications, comprising
a supporting base having a plurality of receptacles, which are configured such that the containers can be inserted into the associated receptacles,
wherein the receptacles extend in the longitudinal direction of the containers and
wherein the receptacles are configured for holding side wall portions of the containers at least partially clamped,
in which supporting structure the receptacles are formed by continuous side walls, and
opening widths of the receptacles can be adjusted by a coordinated adjustment of the side walls of the receptacles between a first position, in which the containers can be inserted into the receptacles, and a second position in which the containers are clamped.

2. The supporting structure of claim 1, wherein the receptacles are configured such
that bottoms or lower ends of the containers can be accessed from a bottom of the supporting base and
that the containers are supported on the supporting base such that all bottoms or lower ends of the containers are disposed or can be disposed at the same distance from an upper surface of the supporting base to span a plane all together.

3. The supporting structure of claim 1, wherein the receptacles have a polygonal cross-section,
wherein the clamping of the containers in the second position of the receptacles is effected by an interaction of opposite side walls of the receptacles and of the cylindrical side walls of the containers.

4. The supporting structure of claim 3, wherein the side walls of the receptacles are formed of a flexible plastic or coated or provided with such a flexible plastic.

5. The supporting structure of claim 1, wherein the supporting base is rectangular or square-shaped in the second position and
wherein the coordinated adjustment is a shearing movement from a first position, in which the supporting base forms a parallelogram in a plan view, to said second position.

6. The supporting structure of claim 1, wherein the receptacles are formed by a plurality of base units which are identical and are in engagement with each other, and
wherein side walls of directly adjacent base units interact with each other such that they are linearly guided for said coordinated adjustment.

7. The supporting structure of claim 6, wherein the base units are formed by intersecting side walls, wherein
two side walls act as guiding walls that are formed with a slot and are provided with at least one elongated hole, and
respective side walls of adjacent base units are linearly guided in a slot of the guiding walls, which are provided with at least one projection which engages in a respective associated elongated hole of an adjacent base unit.

8. The supporting structure of claim 1, wherein the receptacles are open at both ends, wherein a retaining web is formed at the bottom end of the receptacles for supporting the container supported in the respective receptacle.

9. The supporting structure of claim 1, wherein the receptacles are open at both ends, wherein the receptacles comprise an elastic web which biases opposite side wall portions of the receptacles against each another and pulls them together.

10. The supporting structure of claim 1, wherein rim portions of the supporting structure can be removed or pivoted away to reduce the base area of the supporting structure.

11. The supporting structure of claim 1, wherein webs or side walls between the receptacles prevent a direct collision of adjacent containers accommodated therein.

12. A transport or packaging container for a plurality of containers for substances for medical, pharmaceutical or cosmetic applications, comprising
a box-shaped container and
a supporting structure for concurrently supporting a plurality of cylindrical containers, wherein
the supporting structure is accommodated in the box-shaped container,
wherein
the supporting structure comprises a supporting base having a plurality of receptacles, which are configured such that the containers can be inserted into the associated receptacles,
the receptacles extend in the longitudinal direction of the containers and
wherein the receptacles are configured for holding side wall portions of the containers at least partially clamped, and
opening widths of the receptacles can be adjusted by a coordinated adjustment of the side walls of the receptacles between a first position, in which the containers can be inserted into the receptacles, and a second position in which the containers are clamped.

13. The transport or packaging container of claim 12, consisting of at least one antimicrobial thermoplastic, thermosetting or elastomeric plastic to which an antimicrobial powder or glass powder is added.

14. The transport or packaging container of claim 13, wherein the antimicrobial powder or glass powder is added to the plastic material solely or mainly in the portions of the plastic near a surface thereof.

15. The transport or packaging container of claim 12, further comprising a protective or packaging foil which is bonded to an upper rim of the box-shaped container.

16. The transport or packaging container of claim 12, further comprising an identification or tracking means for identifying or tracking the transport or packaging container or the supporting structure with the containers supported therein, wherein
the identification or tracking means is coupled to the supporting structure and/or to the transport or packaging container and/or to the protective or packaging foil in such a manner that it is destroyed upon opening of the transport or packaging container or upon removal or manipulation of the supporting structure or of the containers accommodated therein.

17. The transport or packaging container of claim 16, wherein the identification or tracking means is an RFID chip or a RuBee chip for reading out information in a contactless manner.

18. The transport or packaging container of claim 12, further comprising at least one sensor for monitoring or recording parameters of the transport or packaging container as a function of time.
